(19) United States
(12) Patent Application Publication
(10) Pub. No.: US 2026/0230912 A1
(43) Pub. Date: Aug. 6, 2026

(54) PDU SET MARKING IN QoS FLOWS IN A WIRELESS COMMUNICATION NETWORK

(71) Applicant: Lenovo (Singapore) Pte. Limited, Singapore (SG)

(72) Inventors: Dimitrios Karampatsis, Ruislip (GB); Razvan-Andrei Stoica, Essen (DE)

(73) Assignee: Lenovo (Singapore) Pte. Limited, Singapore (SG)

(21) Appl. No.: 19/152,111

(22) PCT Filed: May 2, 2024
(86) PCT No.: PCT/IB2024/054259

§ 371 Date: Jul. 30, 2025

Related U.S. Application Data
(63) Continuation of application No. 18/340,730, filed on Jun. 23, 2023, now abandoned.

(30) Foreign Application Priority Data
May 2, 2023 (GR) 20230100361

(51) Int. Cl. H04W 28/02; H04L 45/74; H04L 69/08

(52) U.S. Cl. CPC H04W 28/0268; H04L 45/74; H04L 69/08

(57) ABSTRACT

A User Plane Function (UPF) receives a Protocol Data Unit (PDU) in a downlink direction, the received PDU subject to PDU-set processing according to configuration information received from a Session Management Function (SMF), and the configuration information includes a protocol description. The UPF determines whether the received PDU does not match all components of the configuration information, or the received PDU does match the protocol description of the configuration information, and the received PDU is not part of a PDU-set. The UPF creates a header for the received PDU, the header including PDU-set information if either the received PDU does not match all of the components of the configuration information, or the received PDU does match the protocol description of the configuration information, and the received PDU is not part of the PDU-set. The UPF routes the received PDU and the header to a radio access network.

### RELATED APPLICATIONS

This application claims priority to U.S. application Ser. No. 18/340,730 filed Jun. 23, 2023, entitled “PDU Set Marking in QoS Flows in a Wireless Communication Network,” the disclosure of which is incorporated by reference herein in its entirety. The U.S. application Ser. No. 18/340,730 claims priority to Greece Application Serial No. 2413-0004699645 filed May 2, 2023, entitled “PDU Set Marking in QoS Flows in a Wireless Communication Network,” the disclosure of which is incorporated by reference herein in its entirety.

### FIELD

The subject matter disclosed herein relates generally to the field of implementing PDU set marking in QoS flows in a wireless communication network. This document defines a User Plane Function and a method in a User Plane Function.

### BACKGROUND

In the context of XR media traffic, 3GPP SA2 WG recently introduced the concept of End of Burst Indication (EOBI) for signaling to the Next Generation Radio Access Network (NG-RAN) the end of a data burst of multiple PDUs for XR media traffic. The EOBI is optional and is intended to assist the RAN in determining a data burst completion event and to enable low-level radio resource allocation and optimization of connected state discontinuous reception (C-DRX) for improved energy savings. The application server (AS) needs thus to indicate to the 5G system (5GS) the EOBI given its XR traffic and associated XR traffic characteristics.

Furthermore, 3GPP SA2 WG also determined the concept of a PDU set for XR media traffic (XRM) to group a series of PDUs carrying a unit of information at the application-level. A PDU set can thus be treated according to an identical set of QoS requirements and associated constraints of delay budget and error rate while providing support to a radio access network (RAN) for differentiated QoS handling at PDU set level. This improves the granularity of legacy 5G QoS flow framework allowing the RAN to optimize the mapping between QoS flow and DRBs to meet stringent XR media requirements (e.g., high-rate transmissions with short delay budget).

### SUMMARY

If both packets marked with PDU-set information and unmarked packets are sent via such a QoS flow, then the complexity at the RAN increases as the RAN will need to accommodate scheduling resources for PDUs of a PDU-set according to the PDU set delay budget (PDSB) and scheduling resources for non-marked PDU-set packets based on the legacy PDB of the QoS flow, where the PDSB value is higher than the legacy PDB. The solution presented herein comprises enforcing a policy that a QoS Flow enabled with the PDU Set marking must have all the PDUs in the downlink direction marked with PDU Set information upon ingestion into the 5GS over the UPF via the N6 interface. This policy in turn results in that over a QoS Flow enabled with the PDU Set marking will always contain only packets marked with the PDU Set information.

Disclosed herein are procedures for PDU set marking in QoS flows in a wireless communication network. Said procedures may be implemented by a User Plane Function and a method in a User Plane Function.

Accordingly, there is provided a User Plane Function (UPF), comprising a processor and a memory coupled with the processor, the memory containing instructions which when executed by the processor cause the UPF to: receive a Protocol Data Unit (PDU) in a downlink direction the received PDU subject to PDU-set processing according to configuration information received from a Session Management Function (SMF) wherein the configuration information comprises a protocol description; and determine whether: the received PDU does not match all components of the configuration information received from the SMF; or the received PDU does match the protocol description of the configuration information but that the received PDU is not part of a PDU-set. The UPF is further caused to create a header for the received PDU, the header including PDU-set information if either: the received PDU does not match all components of the configuration information received from the SMF; or the received PDU does match the protocol description of the configuration information but that the received PDU is not part of a PDU-set. The processor is further caused to route the received PDU and the header to a radio access network.

There is further provided a method performed by a User Plane Function (UPF), the method comprising: receiving a Protocol Data Unit (PDU) in a downlink direction the received PDU subject to PDU-set processing according to configuration information received from a Session Management Function (SMF) wherein the configuration information comprises a protocol description; and determining whether: the received PDU does not match all components of the configuration information received from the SMF; or the received PDU does match the protocol description of the configuration information but that the received PDU is not part of a PDU-set. The method further comprises creating a header for the received PDU, the header including PDU-set information if either: the received PDU does not match all components of the configuration information received from the SMF; or the received PDU does match the protocol description of the configuration information but that the received PDU is not part of a PDU-set. The method further comprises routing the received PDU and the header to a radio access network.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Methods and apparatus for PDU set marking in QoS flows in a wireless communication network will now be described, by way of example only, with reference to the accompanying drawings, in which:

FIG. 1 depicts an embodiment of a wireless communication system for PDU set marking in QoS flows in a wireless communication network;

FIG. 2 depicts a user equipment apparatus that may be used for implementing the methods described herein;

FIG. 3 depicts further details of the network node that may be used for implementing the methods described herein;

FIG. 4 provides an overview of the RTP and RTCP stack;

FIG. 5 illustrates an overview of the WebRTC stack;

FIGS. 6a and 6b illustrate a packet format and header information for an RTP packet and an SRTP packet respectively;

FIG. 7 illustrates RTP/SRTP header extension format and syntax;

FIG. 8 illustrates an overview of a core network XRM architecture handling of PDU sets;

FIGS. 9a to 9d illustrate 5GS PDU set-aware QoS handling framework description of PDU set to QoS flow to DRB mappings;

FIG. 10 illustrates an example of a scenario comprising different AF sessions for an XR video application and a non-XR application being multiplexed by a 5GS;

FIG. 11 illustrates an example scenario comprising the same AF sessions for an XR application served over WebRTC where the audio and the video are transmitted in multiplex over one RTP stream for an XR application; and

FIG. 12 illustrates a method in a User Plane Function.

### DETAILED DESCRIPTION

If both packets marked with PDU-set information and unmarked packets are sent via such a QoS flow, then the complexity at the RAN increases as the RAN will need to accommodate scheduling resources for PDUs of a PDU-set according to the PDU set delay budget (PDSB) and scheduling resources for non-marked PDU-set packets based on the legacy PDB of the QoS flow, where the PDSB value is higher than the legacy PDB. The solution presented herein comprises enforcing a policy that a QoS Flow enabled with the PDU Set marking must have all the PDUs in the downlink direction marked with PDU Set information upon ingestion into the 5GS over the UPF via the N6 interface. This policy in turn results in that over a QoS Flow enabled with the PDU Set marking will always contain only packets marked with the PDU Set information.

Prior to delving further into the details of the techniques presented herein, note that, as will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatus may be implemented as a hardware circuit comprising custom very-large-scale integration (“VLSI”) circuits or gate arrays, off-the-shelf semiconductors such as logic chips, transistors, or other discrete components. The disclosed methods and apparatus may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, the methods and apparatus may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including”, “comprising”, “having”, and variations thereof, mean “including but not limited to”, unless expressly specified otherwise. An enumerated listing of items does not imply that any or all of the items are mutually exclusive, unless expressly specified otherwise. The terms “a”, “an”, and “the” also refer to “one or more”, unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one, and only one, of any single item in the list. For example, “one of A, B and C” includes only A, only B or only C and excludes combinations of A, B and C. As used herein, “a member selected from the group consisting of A, B, and C” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed method and apparatus are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which executes on the computer or other programmable apparatus provides processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved.

Other steps and methods may be conceived that are equivalent in function, logic, or effect to one or more blocks, or portions thereof, of the illustrated Figures.

The description of elements in each figure may refer to elements of proceeding Figures. Like numbers refer to like elements in all Figures.

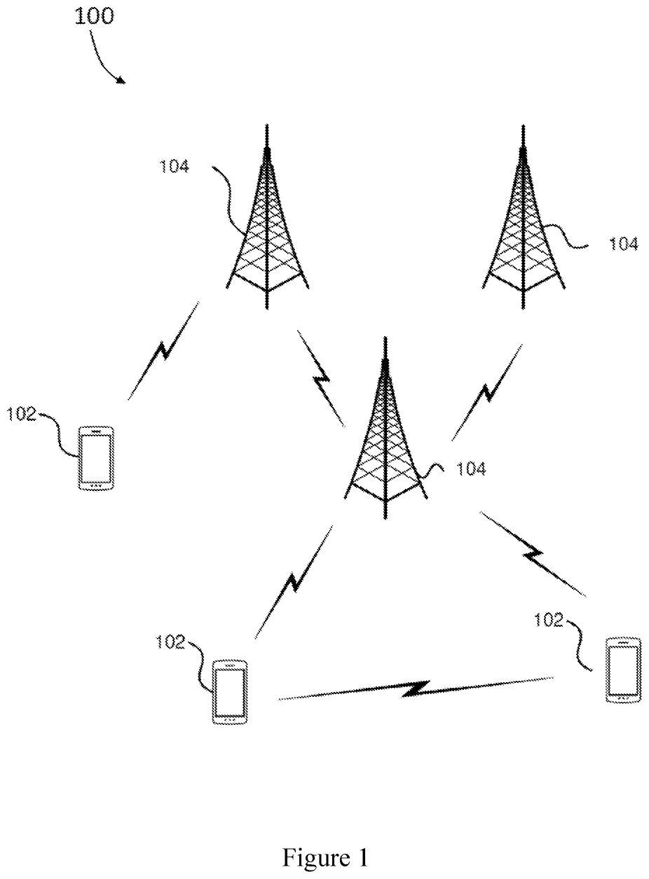

FIG. 1 depicts an embodiment of a wireless communication system 100 for PDU set marking in QoS flows in a wireless communication network. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100. The wireless communication system may comprise a wireless communication network and at least one wireless communication device. The wireless communication device is typically a 3GPP User Equipment (UE). The wireless communication network may comprise at least one network node. The network node may be a network unit.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to as an access point, an access terminal, a base, a base station, a Node-B, an eNB, a gNB, a Home Node-B, a relay node, a device, a core network, an aerial server, a radio access node, an AP, NR, a network entity, an Access and Mobility Management Function (“AMF”), a Unified Data Management Function (“UDM”), a Unified Data Repository (“UDR”), a UDM/UDR, a Policy Control Function (“PCF”), a Radio Access Network (“RAN”), an Network Slice Selection Function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), an application function, a service enabler architecture layer (“SEAL”) function, a vertical application enabler server, an edge enabler server, an edge configuration server, a mobile edge computing platform function, a mobile edge computing application, an application data analytics enabler server, a SEAL data delivery server, a middleware entity, a network slice capability management server, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with New Radio (NR) protocols standardized in 3GPP, wherein the network unit 104 transmits using an Orthogonal Frequency Division Multiplexing (“OFDM”) modulation scheme on the downlink (DL) and the remote units 102 transmit on the uplink (UL) using a Single Carrier Frequency Division Multiple Access (“SC-FDMA”) scheme or an OFDM scheme. More generally, however, the wireless communication system 100 may implement some other open or proprietary communication protocol, for example, WiMAX, IEEE 802.11 variants, GSM, GPRS, UMTS, LTE variants, CDMA2000, Bluetooth®, ZigBee, Sigfox, LoraWAN among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

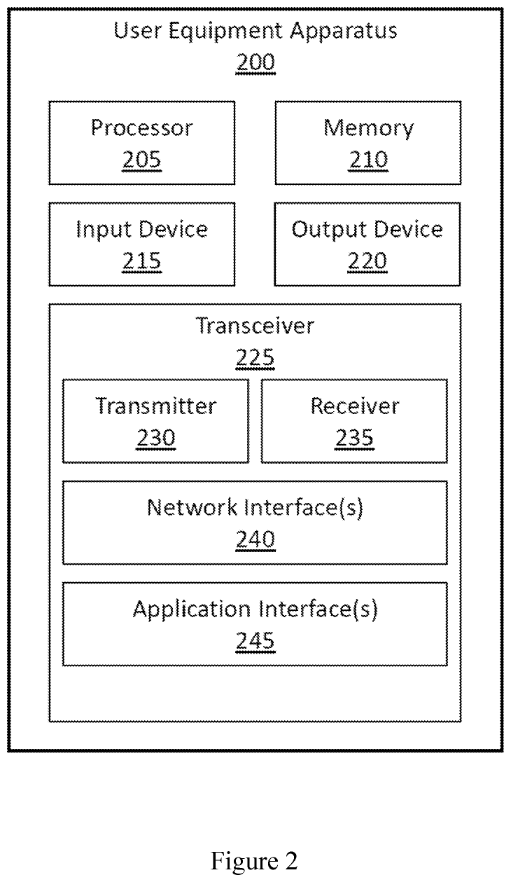

FIG. 2 depicts a user equipment apparatus 200 that may be used for implementing the methods described herein. The user equipment apparatus 200 is used to implement one or more of the solutions described herein. The user equipment apparatus 200 is in accordance with one or more of the user equipment apparatuses described in embodiments herein. In particular, the user equipment apparatus 200 may comprise a remote unit 102, a UE 835, 1035 or 1135 as described herein. The user equipment apparatus 200 includes a processor 205, a memory 210, an input device 215, an output device 220, and a transceiver 225.

The input device 215 and the output device 220 may be combined into a single device, such as a touchscreen. In some implementations, the user equipment apparatus 200 does not include any input device 215 and/or output device 220. The user equipment apparatus 200 may include one or more of: the processor 205, the memory 210, and the transceiver 225, and may not include the input device 215 and/or the output device 220.

As depicted, the transceiver 225 includes at least one transmitter 230 and at least one receiver 235. The transceiver 225 may communicate with one or more cells (or wireless coverage areas) supported by one or more network units. The transceiver 225 may be operable on unlicensed spectrum. Moreover, the transceiver 225 may include multiple UE panels supporting one or more beams. Additionally, the transceiver 225 may support at least one network interface 240 and/or application interface 245. The application interface(s) 245 may support one or more APIs. The network interface(s) 240 may support 3GPP reference points, such as Uu, N1, PC5, etc. Other network interfaces 240 may be supported, as understood by one of ordinary skill in the art.

The processor 205 may include any known controller capable of executing computer-readable instructions and/or capable of performing logical operations. For example, the processor 205 may be a microcontroller, a microprocessor, a central processing unit (“CPU”), a graphics processing unit (“GPU”), an auxiliary processing unit, a field programmable gate array (“FPGA”), or similar programmable controller. The processor 205 may execute instructions stored in the memory 210 to perform the methods and routines described herein. The processor 205 is communicatively coupled to the memory 210, the input device 215, the output device 220, and the transceiver 225.

The processor 205 may control the user equipment apparatus 200 to implement the user equipment apparatus behaviors described herein. The processor 205 may include an application processor (also known as “main processor”) which manages application-domain and operating system (“OS”) functions and a baseband processor (also known as “baseband radio processor”) which manages radio functions.

The memory 210 may be a computer readable storage medium. The memory 210 may include volatile computer storage media. For example, the memory 210 may include a RAM, including dynamic RAM (“DRAM”), synchronous dynamic RAM (“SDRAM”), and/or static RAM (“SRAM”). The memory 210 may include non-volatile computer storage media. For example, the memory 210 may include a hard disk drive, a flash memory, or any other suitable non-volatile computer storage device. The memory 210 may include both volatile and non-volatile computer storage media.

The memory 210 may store data related to implement a traffic category field as described herein. The memory 210 may also store program code and related data, such as an operating system or other controller algorithms operating on the apparatus 200.

The input device 215 may include any known computer input device including a touch panel, a button, a keyboard, a stylus, a microphone, or the like. The input device 215 may be integrated with the output device 220, for example, as a touchscreen or similar touch-sensitive display. The input device 215 may include a touchscreen such that text may be input using a virtual keyboard displayed on the touchscreen and/or by handwriting on the touchscreen. The input device 215 may include two or more different devices, such as a keyboard and a touch panel.

The output device 220 may be designed to output visual, audible, and/or haptic signals. The output device 220 may include an electronically controllable display or display device capable of outputting visual data to a user. For example, the output device 220 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 220 may include a wearable display separate from, but communicatively coupled to, the rest of the user equipment apparatus 200, such as a smart watch, smart glasses, a heads-up display, or the like. Further, the output device 220 may be a component of a smart phone, a personal digital assistant, a television, a table computer, a notebook (laptop) computer, a personal computer, a vehicle dashboard, or the like.

The output device 220 may include one or more speakers for producing sound. For example, the output device 220 may produce an audible alert or notification (e.g., a beep or chime). The output device 220 may include one or more haptic devices for producing vibrations, motion, or other haptic feedback. All, or portions, of the output device 220 may be integrated with the input device 215. For example, the input device 215 and output device 220 may form a touchscreen or similar touch-sensitive display. The output device 220 may be located near the input device 215.

The transceiver 225 communicates with one or more network functions of a mobile communication network via one or more access networks. The transceiver 225 operates under the control of the processor 205 to transmit messages, data, and other signals and also to receive messages, data, and other signals. For example, the processor 205 may selectively activate the transceiver 225 (or portions thereof) at particular times in order to send and receive messages.

The transceiver 225 includes at least one transmitter 230 and at least one receiver 235. The one or more transmitters 230 may be used to provide uplink communication signals to a base unit of a wireless communication network. Similarly, the one or more receivers 235 may be used to receive downlink communication signals from the base unit. Although only one transmitter 230 and one receiver 235 are illustrated, the user equipment apparatus 200 may have any suitable number of transmitters 230 and receivers 235. Further, the transmitter(s) 230 and the receiver(s) 235 may be any suitable type of transmitters and receivers. The transceiver 225 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 225, transmitters 230, and receivers 235 may be implemented as physically separate components that access a shared hardware resource and/or software resource, such as for example, the network interface 240.

One or more transmitters 230 and/or one or more receivers 235 may be implemented and/or integrated into a single hardware component, such as a multi-transceiver chip, a system-on-a-chip, an Application-Specific Integrated Circuit (“ASIC”), or other type of hardware component. One or more transmitters 230 and/or one or more receivers 235 may be implemented and/or integrated into a multi-chip module. Other components such as the network interface 240 or other hardware components/circuits may be integrated with any number of transmitters 230 and/or receivers 235 into a single chip. The transmitters 230 and receivers 235 may be logically configured as a transceiver 225 that uses one more common control signals or as modular transmitters 230 and receivers 235 implemented in the same hardware chip or in a multi-chip module.

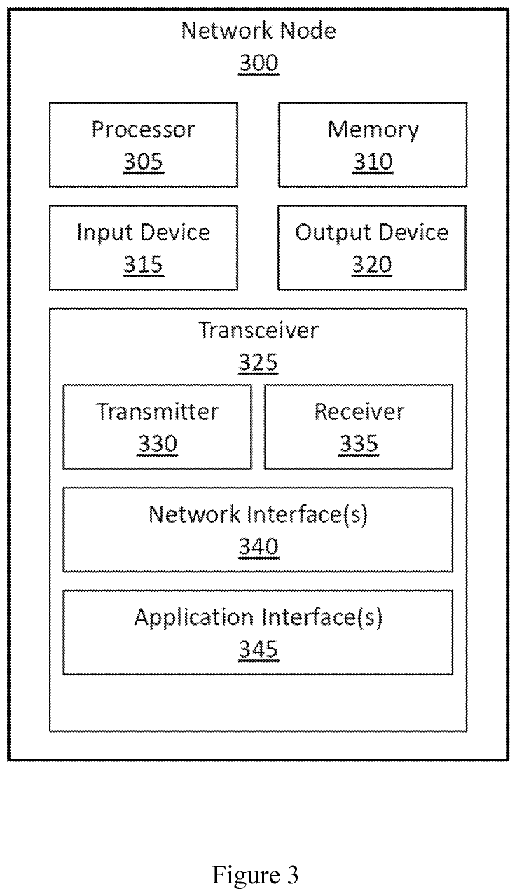

FIG. 3 depicts further details of the network node 300 that may be used for implementing the methods described herein. The network node 300 may be one implementation of an entity in the wireless communication network, e.g. in one or more of the wireless communication networks described herein. The network node 300 may comprise a network unit 104 or a User Plane Function (UPF) as described herein, including 840, 104 and 1140. The network node 300 includes a processor 305, a memory 310, an input device 315, an output device 320, and a transceiver 325.

The input device 315 and the output device 320 may be combined into a single device, such as a touchscreen. In some implementations, the network node 300 does not include any input device 315 and/or output device 320. The network node 300 may include one or more of: the processor 305, the memory 310, and the transceiver 325, and may not include the input device 315 and/or the output device 320.

As depicted, the transceiver 325 includes at least one transmitter 330 and at least one receiver 335. Here, the transceiver 325 communicates with one or more remote units 200.

Additionally, the transceiver 325 may support at least one network interface 340 and/or application interface 345. The application interface(s) 345 may support one or more APIS.

The network interface(s) 340 may support 3GPP reference points, such as Uu, N1, N2 and N3. Other network interfaces 340 may be supported, as understood by one of ordinary skill in the art.

The processor 305 may include any known controller capable of executing computer-readable instructions and/or capable of performing logical operations. For example, the processor 305 may be a microcontroller, a microprocessor, a CPU, a GPU, an auxiliary processing unit, a FPGA, or similar programmable controller. The processor 305 may execute instructions stored in the memory 310 to perform the methods and routines described herein. The processor 305 is communicatively coupled to the memory 310, the input device 315, the output device 320, and the transceiver 325.

The memory 310 may be a computer readable storage medium. The memory 310 may include volatile computer storage media. For example, the memory 310 may include a RAM, including dynamic RAM (“DRAM”), synchronous dynamic RAM (“SDRAM”), and/or static RAM (“SRAM”). The memory 310 may include non-volatile computer storage media. For example, the memory 310 may include a hard disk drive, a flash memory, or any other suitable non-volatile computer storage device. The memory 310 may include both volatile and non-volatile computer storage media.

The memory 310 may store data related to establishing a multipath unicast link and/or mobile operation. For example, the memory 310 may store parameters, configurations, resource assignments, policies, and the like, as described herein. The memory 310 may also store program code and related data, such as an operating system or other controller algorithms operating on the network node 300.

The input device 315 may include any known computer input device including a touch panel, a button, a keyboard, a stylus, a microphone, or the like. The input device 315 may be integrated with the output device 320, for example, as a touchscreen or similar touch-sensitive display. The input device 315 may include a touchscreen such that text may be input using a virtual keyboard displayed on the touchscreen and/or by handwriting on the touchscreen. The input device 315 may include two or more different devices, such as a keyboard and a touch panel.

The output device 320 may be designed to output visual, audible, and/or haptic signals. The output device 320 may include an electronically controllable display or display device capable of outputting visual data to a user. For example, the output device 320 may include, but is not limited to, an LCD display, an LED display, an OLED display, a projector, or similar display device capable of outputting images, text, or the like to a user. As another, non-limiting, example, the output device 320 may include a wearable display separate from, but communicatively coupled to, the rest of the network node 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

The output device 320 may include one or more speakers for producing sound. For example, the output device 320 may produce an audible alert or notification (e.g., a beep or chime). The output device 320 may include one or more haptic devices for producing vibrations, motion, or other haptic feedback. All, or portions, of the output device 320 may be integrated with the input device 315. For example, the input device 315 and output device 320 may form a touchscreen or similar touch-sensitive display. The output device 320 may be located near the input device 315.

The transceiver 325 includes at least one transmitter 330 and at least one receiver 335. The one or more transmitters 330 may be used to communicate with the UE, as described herein. Similarly, the one or more receivers 335 may be used to communicate with network functions in the PLMN and/or RAN, as described herein. Although only one transmitter 330 and one receiver 335 are illustrated, the network node 300 may have any suitable number of transmitters 330 and receivers 335. Further, the transmitter(s) 330 and the receiver(s) 335 may be any suitable type of transmitters and receivers.

In the context of XR media traffic, 3GPP SA2 WG recently introduced the concept of End of Burst Indication (EOBI) for signaling to the Next Generation Radio Access Network (NG-RAN) the end of a data burst of multiple PDUs for XR media traffic. The EOBI is optional and is intended to assist the RAN in determining a data burst completion event and to enable low-level radio resource allocation and optimization of connected state discontinuous reception (C-DRX) for improved energy savings. The application server (AS) needs thus to indicate to the 5G system (5GS) the EOBI given its XR traffic and associated XR traffic characteristics.

Furthermore, 3GPP SA2 WG also determined the concept of a PDU set for XR media traffic (XRM) to group a series of PDUs carrying a unit of information at the application-level. A PDU set can thus be treated according to an identical set of QoS requirements and associated constraints of delay budget and error rate while providing support to a radio access network (RAN) for differentiated QoS handling at PDU set level. This improves the granularity of legacy 5G QoS flow framework allowing the RAN to optimize the mapping between QoS flow and DRBs to meet stringent XR media requirements (e.g., high-rate transmissions with short delay budget).

One problem related to the latter activity is how the PDU set information (i.e., PDU set boundaries, PDU set importance) is communicated between an application and the 5GS. This document addresses that problem from an application-centric perspective whereby the application, i.e., either the application logic on a UE device or the application server of the application provider, determines and signals PDU set information to the 5GS core network. This signaling is provided in real-time with low signaling/control overhead to enable QoS performance benefits based on the PDU set concept.

Hereafter extended Reality (XR) is used as an umbrella term for different types of realities, of which Virtual Reality, Augmented Reality, and Mixed Reality are examples.

Virtual Reality (VR) is a rendered version of a delivered visual and audio scene. The rendering is in this case designed to mimic the visual and audio sensory stimuli of the real world as naturally as possible to an observer or user as they move within the limits defined by the application. Virtual reality usually, but not necessarily, requires a user to wear a head mounted display (HMD), to completely replace the user's field of view with a simulated visual component, and to wear headphones, to provide the user with the accompanying audio. Some form of head and motion tracking of the user in VR is usually also necessary to allow the simulated visual and audio components to be updated to ensure that, from the user's perspective, items and sound sources remain consistent with the user's movements. In some implementations additional means to interact with the virtual reality simulation may be provided but are not strictly necessary.

Augmented Reality (AR) is when a user is provided with additional information or artificially generated items, or content overlaid upon their current environment. Such additional information or content will usually be visual and/or audible and their observation of their current environment may be direct, with no intermediate sensing, processing, and rendering, or indirect, where their perception of their environment is relayed via sensors and may be enhanced or processed.

Mixed Reality (MR) is an advanced form of AR where some virtual elements are inserted into the physical scene with the intent to provide the illusion that these elements are part of the real scene.

XR refers to all real-and-virtual combined environments and human-machine interactions generated by computer technology and wearables. It includes representative forms such as AR, MR and VR and the areas interpolated among them. The levels of virtuality range from partially sensory inputs to fully immersive VR. In some circles, a key aspect of XR is considered to be the extension of human experiences especially relating to the senses of existence (represented by VR) and the acquisition of cognition (represented by AR).

In 3GPP Release 17, SA4 analyzed the XR traffic model, as described in 3GPP Technical Report TR 26.926 (v1.3.0—January 2023) titled “Traffic Models and Quality Evaluation Methods for Media and XR Services in 5G Systems”, and concluded the QoS requirements in terms of delay budget, data rate and error rate necessary for a satisfactory experience at the application level. These led to 4 additional 5QIs for the 5GS XR QOS flows as delay-critical GBR 5QIs valued 87-90. These are described at 3GPP Technical Specification TS 23.501(v18.1.0—April 2023) titled “System architecture for the 5G System (5GS)” and in particular Table 5.7.4-1. The latter are applicable to XR video streams and control metadata necessary to provide immersive and interactive XR experiences.

XR video traffic is mainly composed of multiple DL/UL video streams of high resolution (e.g., at least 1080p dual-eye buffer usually), frames-per-second (e.g., 60+ fps) and high bandwidth (e.g., usually at least 20-30 Mbps) which needs to be transmitted across a network with minimal delay (typically upper bounded by 15-20 ms) to maintain a reduced end-to-end application round-trip interaction delay. The latter requirements are of critical importance given the XR application dependency on cloud/edge processing (e.g., content downloading, viewport generation and configuration, viewport update, viewport rendering, media encoding/transcoding etc.).

The traffic of immersive and interactive XR applications as the ones described above require often real-time suited transport architectures and protocols. As part of the latter, the state of art is represented by the Real-time Transport Protocol (RTP, as defined in IETF standard RFC 3550-RTP: A Transport Protocol for Real-Time Applications), its securely provisioned Secure Real-time Transport Protocol (SRTP, as defined in IETF standard RFC 3711—The Secure Real-time Transport Protocol), and its web-targeted stack Web Real-Time Communications WebRTC (defined by w3.org in WebRTC 1.0: Real-Time Communication Between Browsers), respectively.

RTP is a media codec agnostic network protocol with application-layer framing used to deliver multimedia (e.g., audio, video etc.) data in real-time over IP networks. It is used in conjunction with a sister protocol for control, i.e., Real-time Transport Control Protocol (RTCP), to provide end-to-end features such as jitter compensation, packet loss and out-of-order delivery detection, synchronization, and source streams multiplexing.

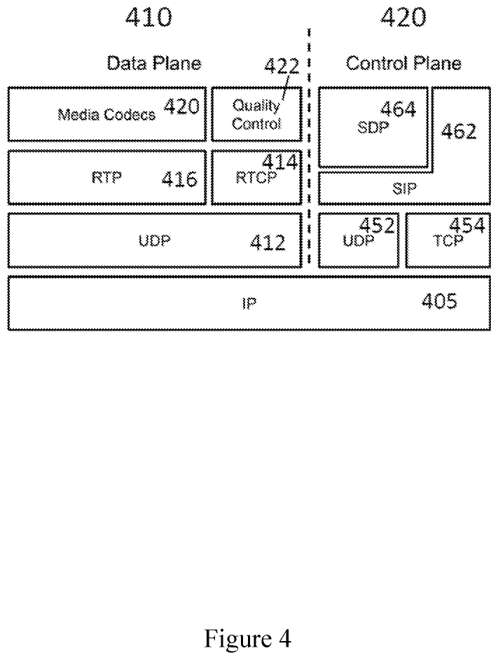

FIG. 4 provides an overview of the RTP and RTCP stack. An IP layer 405 carries signaling from the data plane 410 and form the control plane 450. The data plane 410 stack comprises functions for a User Datagram Protocol (UDP) 412, RTP 416, RTCP 414, Media codecs 420 and quality control 422. The control plane 450 stack comprises functions for UDP 452, Transmission Control Protocol (TCP) 454, Session Initiation Protocol (SIP) 462 and Session Description Protocol (SDP) 464.

SRTP is a secured version of RTP, and is defined by the IETF in RFC 3711 “The Secure Real-time Transport Protocol (SRTP)”. SRTP provides encryption (mainly by means of payload confidentiality), message authentication and integrity protection (by means of PDU, i.e., headers and payload, signing), as well as replay attack protection. Similarly to RTP, the SRTP sister protocol is SRTCP. This provides the same functions to its RTCP counterpart. As such, in vanilla SRTP versions, the RTP header information is still accessible but non-modifiable, whereas the payload is encrypted. These security provisions are illustrated in part over the right-hand side of FIG. 3. Furthermore, the key exchange and additional security parameters necessary to use SRTP are based upon the Datagram Transport Layer Security (DTLS) key exchange procedure. SRTP is used for these reasons as the transport protocol for media in the WebRTC stack which ensures secure RTC multimedia communications over web browser interfaces.

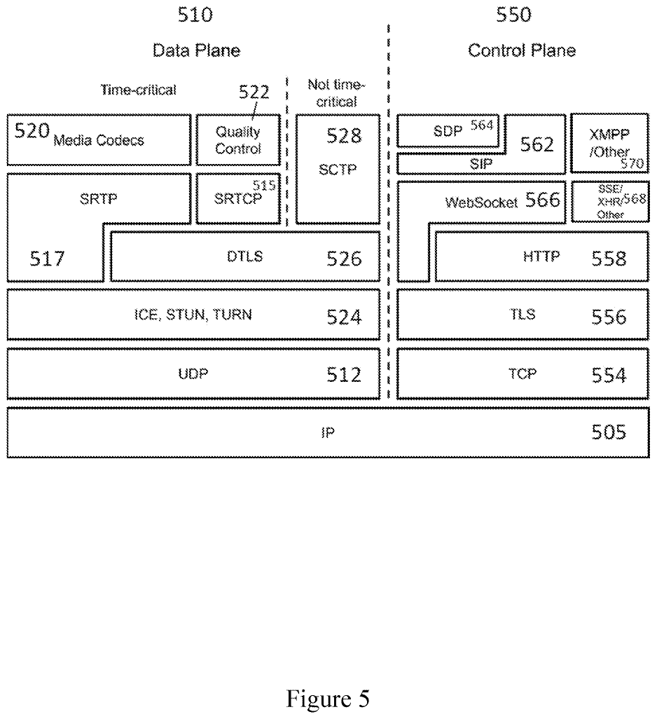

FIG. 5 illustrates an overview of the WebRTC stack. As illustrated, an IP layer 505 carries signaling from the data plane 510 and the control plane 550. The data plane stack 510 comprises functions for User Datagram Protocol (UDP) 512, Interactive Connectivity Establishment (ICE) 524, Datagram Transport Layer Security (DTLS) 526, SRTP 517, SRTCP 515, media codecs 520, Quality Control 522 and SCTP 528. ICE 524 may use the Session Traversal Utilities for NAT (STUN) protocol and Traversal Using Relays around NAT (TURN) to address real-time media content delivery across heterogeneous networks and NAT rules and firewalls. The SCTP data plane 728 is mainly dedicated as an application data channel and may be non-time critical. The SRTP based stack 517 and elements of control, i.e., SRTCP 515, encoding, i.e., media codecs, and Quality of Service (QOS), i.e., Quality Control, are dedicated to time-critical transport. The control plane 550 stack comprises functions for Transmission Control Protocol (TCP) 554, Transport Layer Security (TLS) 556, Hypertext Transfer Protocol (HTTP) 558, WebSocket 566, Session Initiation Protocol (SIP) 562, Session Description Protocol (SDP) 564, Server-sent Events (SSE) 568 and Extensible Messaging and Presence Protocol (XMPP) 570.

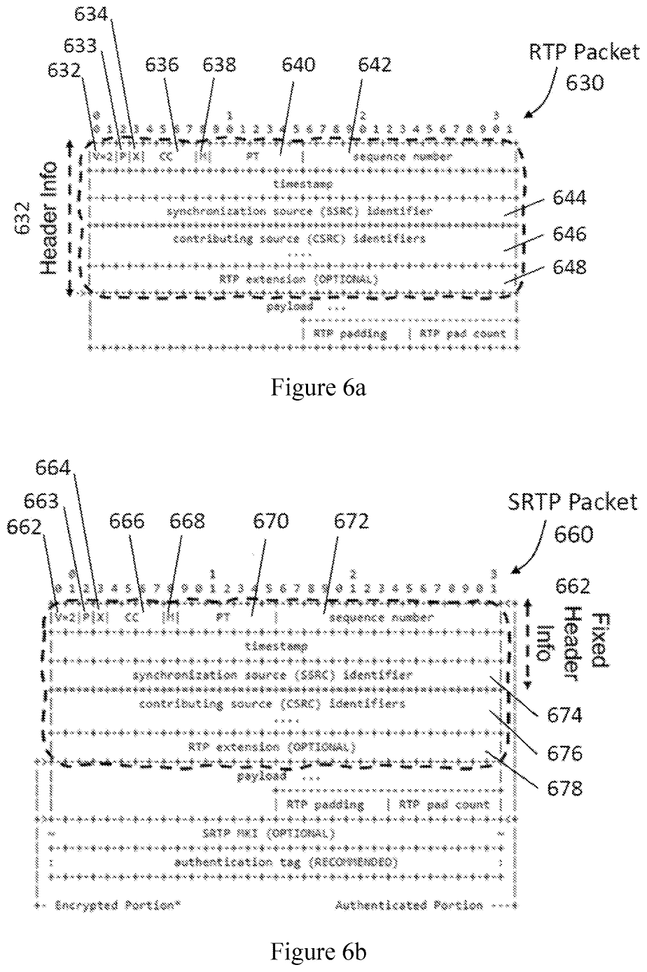

FIG. 6a illustrates a packet format and header information for an RTP packet 630 and FIG. 6b illustrates a packet format and header information for an SRTP packet 660. The individual fixed header information and complete header information (including header extensions) is briefly summarized for the RTP/SRTP packets as follows.

Fixed Header Info comprises “V” 632, 662, “P” 633, 663, “X” 634, 664, “CC” 636, 666, “M” 638, 668, “PT” 640, 670, “Sequence number” 642, 672, “Timestamp” 644, 674, “Synchronization Source (SSRC) identifier” 646, 676, and “Contributing Source (CSRC) identifier” 648, 678.

“V” 632, 662 is 2 bits indicating the protocol version used.

“P” 633, 663 is a 1 bit field indicating that one or more zero-padded octets at the end of the payload are present, whereby, among others, the padding may be necessary for fixed-sized encrypted blocks or for carrying multiple RTP/SRTP packets over lower layer protocols.

“X” 634, 664 is a 1 bit indicating that the standard fixed RTP/SRTP header will be followed by an RTP header extension usually associated with a particular data/profile that will carry more information about the data (e.g., the frame marking RTP header extension for video data (as defined in IETF RFC 3711—The Secure Real-time Transport Protocol (SRTP)), or generic RTP header extensions such as the RTP/SRTP extended protocol (as defined by w3.org in WebRTC 1.0: Real-Time Communication Between Browsers)).

“CC” 636, 666 is a 4 bit field indicating number of contributing media sources (CSRC) that follow the fixed header

“M” 638, 668 is 1 bit intended to mark an information frame boundary in the packet stream, whose behavior is exactly specified by RTP profiles (e.g., H.264, H.265, H.266, AV1 etc.)

“PT” 640, 670 is 7 bits indicating the payload type, which in case of video profiles is dynamic and negotiated by means of SDP (e.g., 96 for H. 264, 97 for H. 265, 98 for AV 1 etc.)

“Sequence number” 642, 672 is 16 bits indicating the sequence number which increments by one with each RTP data packet sent over a session

“Timestamp” 644, 674 is 32 bits indicating timestamp in ticks of the payload type clock reflecting the sampling instant of the first octet of the RTP data packet (associated for video stream with a video frame), whereas the first timestamp of the first RTP packet is selected at random.

“Synchronization Source (SSRC) identifier” 646, 676 is a 32 bit field indicating a random identifier for the source of a stream of RTP packets forming a part of the same timing and sequence number space, such that a receiver may group packets based on synchronization source for playback.

“Contributing Source (CSRC) identifier” 648, 678 is a list of up to 16 CSRC items of 32 bits each given the amount of CSRC mixed by RTP mixers within the current payload as signaled by the CC bits; the list identifies the contributing sources for the payload contained in this packet given the SSRC identifiers of the contributing sources.

Complete Header Information (incl. header extensions) comprises “RTP header extension” 648, 678.

“RTP header extension” 648, 678 is a variable length field present if the X bit is marked; the header extension is appended to the RTP fixed header information after the CSRC list if present; the RTP header extension is 32-bit aligned and formed of the following fields:
A 16-bit extension identifier defined by a profile and usually negotiated and determined via the Session Description Protocol (SDP) signaling mechanism;
A 16-bit length field describing the extension header length in 32-bits multiples excluding the first 32 bits corresponding to the 16 bits extension identifier and the 16 bits length fields itself; and
A 32-bit aligned header extension raw data field formatted according to some RTP header extension identifier specified format.

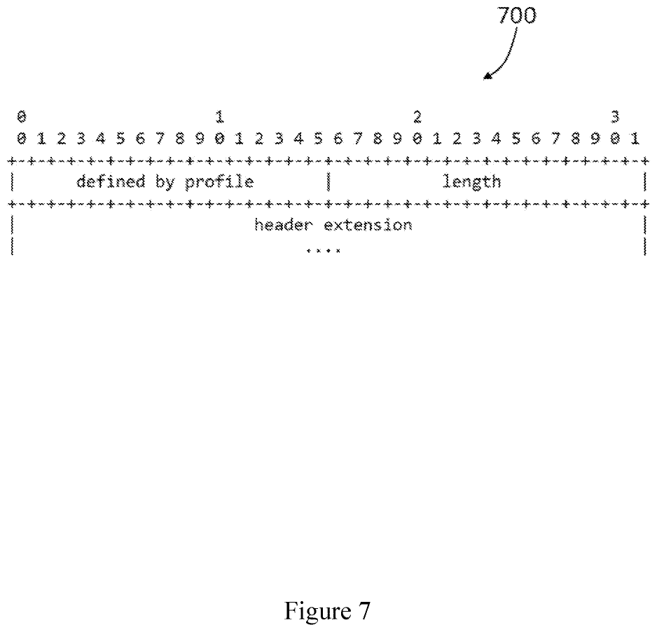

FIG. 7 illustrates RTP/SRTP header extension format and syntax 700. The RTP header extension format and syntax are like the ones of SRTP. A sketch of these is thus commonly provided as shown in FIG. 7. In addition, in both RTP and SRTP only one RTP extension header may be appended to the fixed header information, as defined in IETF RFC 3550-RTP: A Transport Protocol for Real-Time Applications. However, for both RTP and SRTP extensions to the base protocols exist to allow for multiple RTP header extensions of predetermined types to be appended to the fixed header information of the protocols, as per RFC 8285: A General Mechanism for RTP Header Extensions (rfc-editor.org).

In some embodiments, RTP header extensions produced at the source may be ignored by the destination endpoints that do not have the knowledge to interpret and process the RTP header extensions transmitted by the source endpoint.

The study of XR Media (XRM) at the CN level in Release 18 of the 3GPP technical standards introduced the concept of a PDU set to handle QoS requirements of XRM applications and streams with a better granularity beyond QoS flow possibilities. As such, according to 3GPP Technical Report TR 23.700-60 (v0.0.3), a PDU set is composed of one or more PDUs carrying the payload of one unit of information generated at the application level (e.g. a frame or video slice for XRM Services). In some implementations all PDUs in a PDU Set are needed by the application layer to use the corresponding unit of information. In other implementations, the application layer can still recover parts or all of the information unit, when some PDUs are missing.

In addition, the PDU set is associated with QoS requirements in terms of delay budget and error rate, which may be defined as PDU Set Delay Budget (PSDB), and/or as a PDU Set Error Rate (PSER) as defined in 3GPP Technical Report TR 23.700-60 (v0.0.3—May 2022) titled “Study on XR (Extended Reality) and media services” and 3GPP Technical Specification TS 23.501(v18.1.0—April 2023) titled “System architecture for the 5G System (5GS)”. The PDU Set Delay Budget (PSDB) defines an upper bound for the time that a PDU-Set may be delayed between the UE and the N6 termination point at the UPF. PSDB applies to the DL PDU-Set received by the UPF over the N6 interface, and to the UL PDU-Set sent by the UE, and respectively. The PDU Set Error Rate (PSER) defines an upper bound for the rate of PDU-Sets (e.g. set of IP packets constituting a PDU-Set) that have been processed by the sender of a link layer protocol (e.g. RLC in RAN of a 3GPP access). The PSER may be used to determine an upper bound for a rate of non-congestion-related packet losses.

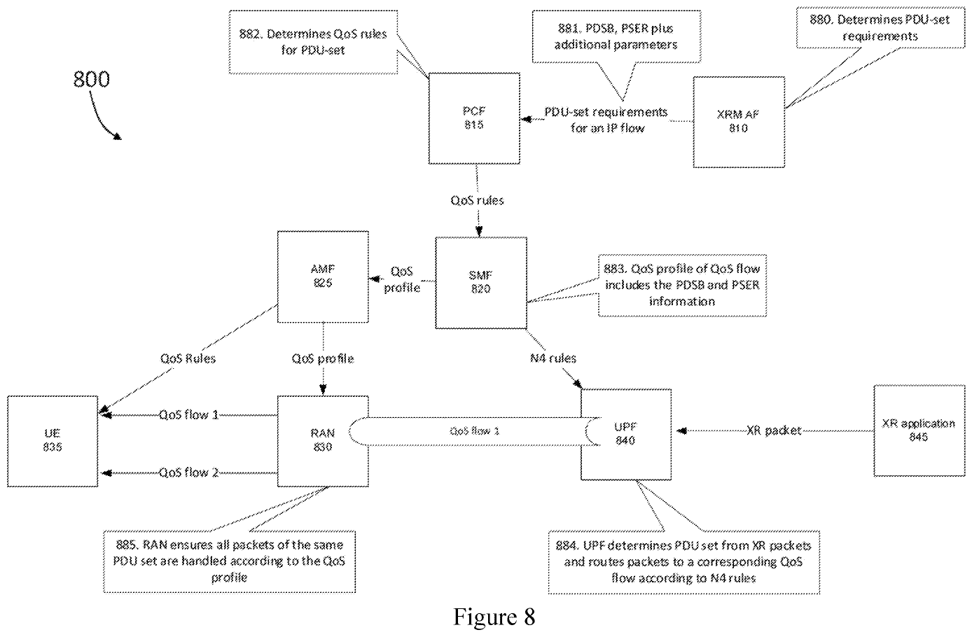

FIG. 8 illustrates an overview of a core network (CN) XRM architecture handling of PDU sets. FIG. 8 shows a system 800 comprising an Extended Reality Media Application Function (XRM AF) 810, a Policy and Control Function (PCF) 815, a Session Management Function (SMF) 820, an Access and Mobility Function (AMF) 825, a Radio Access Network (RAN 830, a User Equipment (UE) 835, a User Plane Function (UPF) 840, and an Extended Reality Application 845. The UE 835 may comprise a remote unit 102, a user equipment apparatus 200, a UE, 1035 or 1135 as described herein. The UPF 840 may comprise a network unit 104, a network node 300, or a User Plane Function (UPF) as described herein such as UPF 1040 and 1140. The operation of system 800 will now be described in the example of downlink traffic, a similar process may operate for uplink traffic.

At 880, the XRM AF 810 determines PDU-set requirements.

At 881, the XRM Application Function 810 provides QoS requirements for packets of a PDU set to the PCF 815 and information to identify the application (i.e. 5-tuple or application id). The QoS requirements may comprise PSDB and PSER. The XRM AF 810 may also include an importance parameter for a PDU set and information for the core network to identify packets belonging to a PDU set.

At 882, the PCF 815 derives QoS rules for the XR application and specific QoS requirements for the PDU set and configures the SMF 820. The QoS rules may use a 5G QoS identifier (5QI) for XR media traffic. The PCF 815 sends the QoS rules to the SMF 820. The PCF 815 may include in the communication to the SMF 820 PCC rules per importance of a PDU set. The PCC rules may be derived according to information received from the XRM AF 810 or based on an operator configuration.

At 883, the SMF 820 establishes a QoS flow according to the QoS rules by the PCF 815 and configures the UPF to route packets of the XR application to a QoS flow, and, in addition, to enable PDU set handling. The SMF 820 also provides the QoS profile containing PDU set QoS requirements to the RAN 830 via the AMF 825. The AMF 825 may provide the QoS profile containing PDU set QoS requirements to the RAN 830 in an N2 SM container. Further, the AMF 825 may provide the QoS rules to the UE 835 in an N1 SM container.

At 884, the UPF 840 inspects the packets and determines packets belonging to a PDU set. The packet inspection may comprise inspecting the RTP packets. When the UPF 840 detects packets of a PDU set the UPF 840 marks the packets belonging to a PDU set within a GTP-U header. The GTP-U header information includes a PDU set sequence number and the size of the PDU set. The UPF 840 may also determine the importance of the PDU set either based on UPF 840 implementation means, information provided by the XRM AF 810 or information provided as metadata from an XRM application server. Based on the importance of the PDU set the UPF 840 may route the traffic to a corresponding QoS flow 1 (according to the rules received from the SMF 820) or include the importance of the PDU set within a GTP-U header. QoS flow 1 may comprise GTP-U headers, and these may include PDU set information.

At 885, the RAN 830 identifies packets belonging to a PDU set (based on the GTP-U marking) and handles the packets of the PDU-set according to the QoS requirements of the PDU set provided by the SMF 820. In one implementation the RAN 830 node may use a different radio bearer with higher QoS requirement (according to the PDU set PSDB/PSER) to guarantee delivery of the packets of the PDU-set, while using a different radio bearer according to the 5QI of the QoS flow for the non-PDU-set packets. RAN 830 may receive QFIs, QoS profile of QoS flow from SMF 820 (via AMF 825) during PDU session establishment/modification which includes PDSB and PSER. RAN 830 inspects GTP-U headers and ensures all packets of the same PDU set are handled according to the QoS profile. This may include packets of PDU-set in a radio bearer carrying QoS flow 1. This may also include sending packets not belonging to the PDU-set in a different radio bearer carrying QoS flow 2.

The above example relates to downlink (DL) traffic. Reciprocal processing is applicable to uplink (UL) traffic wherein the role of UPF 840 packet inspection is taken by the UE 835 which is expected to inspect uplink packets, determine packets belonging to a PDU set, and signal accordingly the PDU set to the RAN 830 for scheduling and resource allocation corresponding to an associated DRB fulfilling capable of fulfilling the PDU set QoS requirements (i.e., PSDB and PSER). The low-level signaling mechanism associated with the UL UE-to-RAN information passing are up to the specification and implementations of RAN signaling procedures.

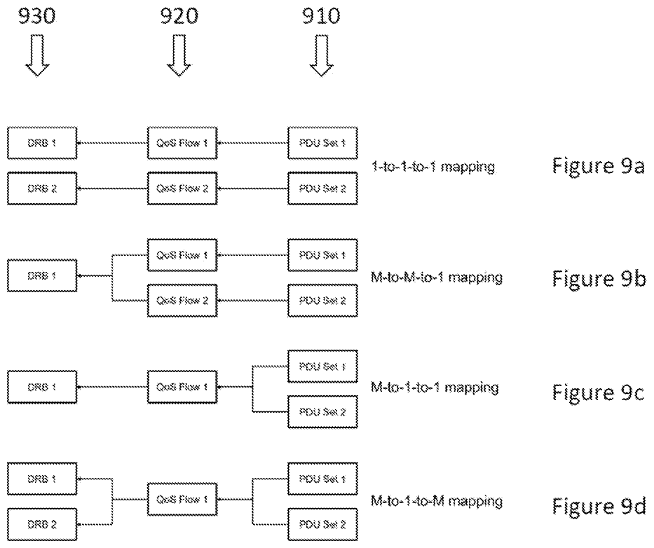

FIGS. 9a to 9d illustrate 5GS PDU set-aware QoS handling framework description of PDU set to QoS flow to DRB mappings. Depending on the QoS flow mappings and RAN procedures, several alternative PDU set to QoS flow to DRB mappings are possible given two distinct PDU sets with different PDU set attributes, such as PDU set importance. FIG. 9 illustrates some options where two PDU sets 910 of different importance and characteristics are mapped to QOS flows 920 and respectively to Data Radio Bearers (DRBs) 930. Consider in this example PDU set 1 to be of high importance with strict QoS requirements (i.e., PSDB, PSER etc.) and PDU set 2 to be of low importance with potentially lower QoS requirements (i.e., PSDB, PSER etc.) than PDU set 1. As illustrated in FIG. 9, the PDU set 910 to QoS flow 920 to DRB 930 can take the following instantiations depending on QoS flow policies and Layer 2 RAN procedures:
FIG. 9a illustrates 1-to-1-to-1 mapping: whereby the separation of QoS flows 920 and DRBs 930 is complete between high and low importance PDU sets 910 optimizing finely the radio and network resources on a per PDU set basis.
FIG. 9b illustrates M-to-M-to-1 mapping: whereby the separation between high and low importance PDU sets 910 is performed only at QoS flow level, whereas the same DRB 930 is used for the over-the-air transmission of both PDU sets 910, which may lead to overprovisioning of radio resources for low importance PDU sets 910 yet require a lower overhead of RAN complexity and management.
FIG. 9c illustrates M-to-1-to-1 mapping: whereby there is no separation between the QOS flows 920 and DRBs 930 of different importance PDU sets 910 and the higher importance PDU set QoS requirements are prioritized in handling the QoS management across both CN and RAN; this may lead to overprovisioning of resources for low importance PDU sets 910 in both CN and RAN implementations but requires lower overhead and control within the 5GS QoS framework.
FIG. 9d illustrates M-to-1-to-M mapping: whereby there is no separation across the QoS flows 920 between PDU set importance levels, yet distinct DRBs 930 are used to cater for the individual requirements of the distinct importance levels; this compromises the QoS flow management complexity and uses PDU set information to filter the PDU sets 910 on different DRBs 930 in order to better match the QoS requirements at RAN level and optimize resource allocation according to individual PDU set needs.

The determination of PDU sets is a prerequisite to control the PDU set flow through the 5GS and implicitly to control the QoS flow to DRB mapping within the QoS 5GS framework. Therefore, to support PDU Set based QoS handling, the PDU session anchor (PSA) UPF identifies PDUs that belong to PDU Sets and determines the PDU Set Information which it sends to the NG-RAN in the GTP-U header. The PDU Set information is used by the NG-RAN for PDU Set based QoS handling as described above.

The PDU Set Information comprises:
PDU Set Sequence Number (PSSN).
Indication of End PDU (E) of the PDU Set
PDU Sequence Number (PSN) within a PDU Set
PDU Set Size (PSS) in bytes.
PDU Set Importance (PSI), which identifies the relative importance of a PDU Set compared to other PDU Sets within a QoS Flow.

The RAN lower layers can further make use of the PDU Set Importance marked within a QoS Flow for PDU Set level packet discarding in presence of congestion over the radio air interface. Furthermore, the interrelation between PSI across multiple QoS flows may be considered.

The SMF instructs the PSA UPF to perform PDU Set marking and may provide the PSA UPF the Protocol Description served over a 5 tuple (i.e., a tuple formed of source IP address, destination IP address, source port, destination port, and protocol number) or an application ID (i.e., an identifier of one or more AF sessions associated with an application) indicating the header, extension header (e.g., RTP/SRTP) and payload type (e.g. H.264) used by the service data flow. The Protocol Description may be received in the PCC rule, based on information provided by the AF or by PCF local policies.

Consequently, the PSA UPF can identify the PDU Set information by using the Protocol Description and the received RTP/SRTP headers, as indicated by a UPF, (as for example described in U.S. provisional patent application 63/428,026, filed 25 Nov. 2022 [Applicants ref: SMM 920220198-US-PSP], incorporated herein by reference) over an RTP header extension for PDU set information. Alternatively, the PSA UPF can identify the PDU Set information by using UPF implementation specific means, (as for example described in PCT application PCT/EP 2022/077327 filed on 30 Sep. 2022 [Applicants ref: SMM920220109-GR-NP], incorporated herein by reference) whereby at least the RTP/SRTP timestamp, synchronization source identifier and M-bit end of frame marker are utilized to determine the boundaries of a PDU Set, and the PDU set size is utilized to determine the PDU set importance based on the available application traffic and codec configuration information. As a result, for each DL PDU received on N6 for which PDU Set based QoS handling is indicated from the SMF, the PSA UPF applies the rules for PDU Set identification and provides PDU Set information which is available to the RAN in the GTP-U header.

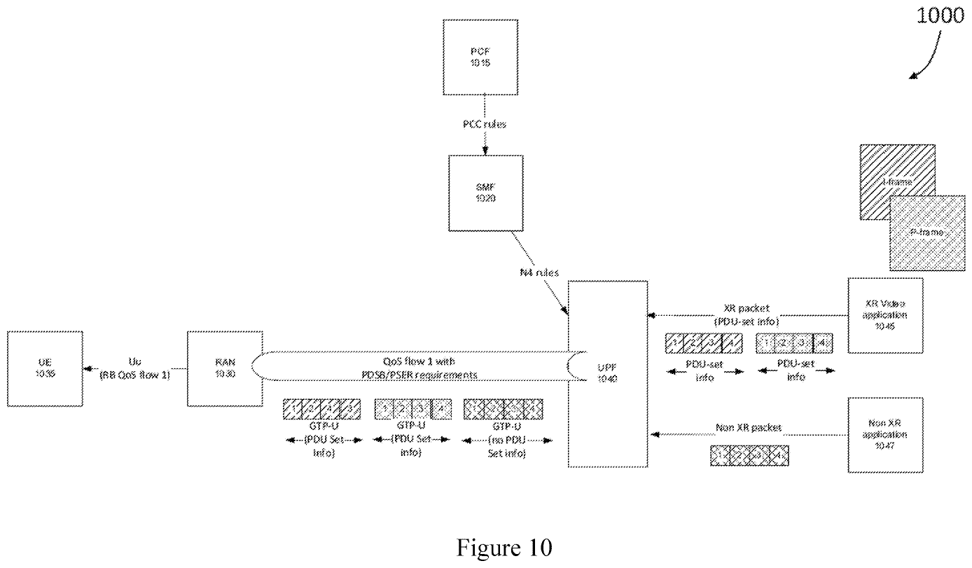

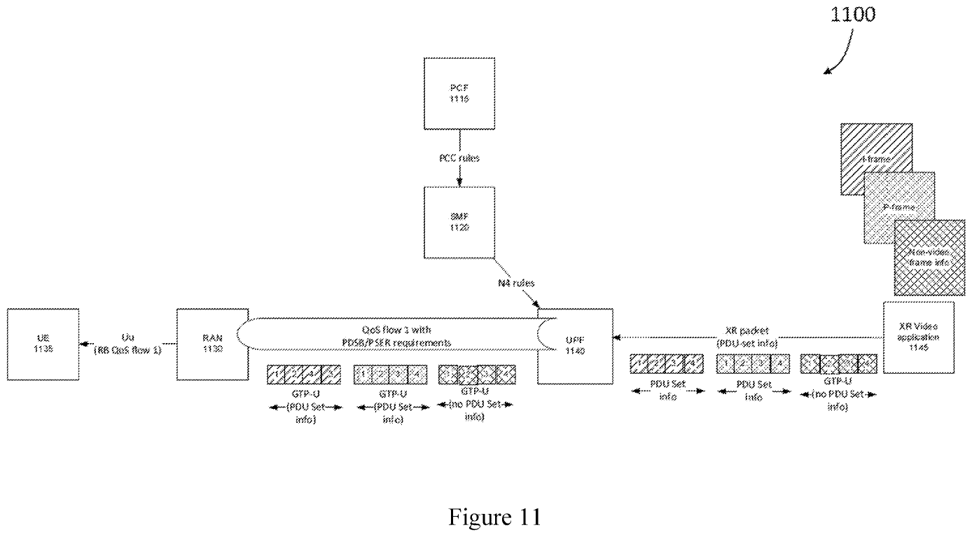

However, the currently defined architecture lacks the technical details necessary to resolve QoS flows that must transport both PDU Set marked and non-PDU Set marked traffic. There are a couple of scenarios possible: Scenario #1 (Different AF sessions) is illustrated in FIG. 10; and Scenario #2 (Same AF sessions) is illustrated in FIG. 11.

Scenario #1 comprises Different AF sessions. A QOS Flow that is established with a PDU Set QoS parameters configuration (e.g., by means of Nnef_AFsession WithQoS service) may also satisfy the QoS requirements of another AF session (either belonging to the same XR application or not) with similar PDB and PER as that of the PDUs enclosed in the PDU Sets. In such a case, an operator's general policies and PCC rules may assign the PDU Set marked and non-PDU Set marked PDUs on the same QoS Flow.

FIG. 10 illustrates an example of a scenario comprising different AF sessions for an XR video application and a non-XR application being multiplexed by a 5GS under the current PCF policies and PCC rules over the same QoS Flow, i.e., QoS Flow 1 that satisfies both the PSDB and PSER requirements of the PDU Set marked XR service traffic, and the PDB and PER of the non-PDU Set marked non-XR service traffic.

FIG. 10 illustrates a scenario #1 representing two different AF sessions combining PDU Set marked and non-PDU Set marked PDUs over a QoS flow with the same QoS parameters. The illustrated system 1000 comprises a PCF 1015 an SMF 1020, a UPF 1040, a RAN 1030, a UE 1035, an XR video application 1045, and a non-XR video application 1047. The UE 1035 may comprise a remote unit 102, a user equipment apparatus 200, a UE 835 or 1135 as described herein. The UPF 1040 may comprise a network unit 104, a network node 300, or a User Plane Function (UPF) as described herein such as UPF 840 and 1140. The XR video application 1045 transmits an I-frame as a plurality of PDUs, the PDUs grouped to form a PDU set. The XR video application 1045 also transmits a P-frame as a plurality of PDUs, those PDUs also grouped to form a PDU set. The non-XR application 1047 transmits other data as a plurality of PDUs, the PDUs grouped to form a further PDU set. The UPF 1040 is arranged to receive PDUs from both the XR video application 1045, and the non-XR video application 1047 and transmit PDUs to the RAN 1030 a QoS flow having PDSB/PSER requirements. The UPF 1040 includes PDU set information with PDUs from the XR video application 1045. The UPF 1040 does not include PDU set information with PDUs from the non-XR application 1047. The RAN 1030 transmits PDUs to the UE 1035 via a Uu radio bearer.

Scenario #2 comprises the Same AF sessions. A QOS Flow that is established with a PDU Set QoS parameters configuration (e.g., by means of Nnef_AFsession WithQoS service) may be exposed to both PDU Set and non-PDU Set marked traffic. This can happen for instance in case of WebRTC services whereby multiple media streams are multiplexed over a single RTP stream served over one AF session instance. Alternatively, this can also happen for media streams belonging to the same XR application (i.e., sharing the application ID) which are mapped given their 5 tuples and QoS requirements to the same QoS Flow. For example, multiple cameras capturing systems, e.g., as for 360 degrees surround video, or alternatively, at least two cameras for 2D+depth video information, may be used concurrently over different RTP streams. In any of these examples, a use case that is common is that at least one of the media streams does not contain PDU Set marking. In an example this may be since the PDU Set may not support a particular video codec specification (e.g., VP8, VP9, AV1), a particular audio codec specification (e.g., OPUS), a particular multimedia codec specification (e.g., tactile codecs), or alternatively, any multimedia codec specification except video (e.g., audio codecs, tactile codecs etc.).

FIG. 11 illustrates an example scenario comprising the same AF sessions for an XR application served over WebRTC where the audio (e.g., OPUS encoded bitstream) and the video (e.g., H.264 constrained baseline encoded bitstream) are transmitted in multiplex over one RTP stream for an XR application.

FIG. 11 illustrates a scenario #2 representing one AF session multiplexing PDU Set marked and non-PDU Set marked PDUs over a QoS flow with the same QoS parameters. The illustrated system 1100 comprises a PCF 1115 an SMF 1120, a UPF 1140, a RAN 1130, a UE 1135, and an XR video application 1145. The XR video application 1145 comprises a WebRTC App. The UE 1135 may comprise a remote unit 102, a user equipment apparatus 200, a UE 835 or 1035 as described herein. The UPF 1140 may comprise a network unit 104, a network node 300, or a User Plane Function (UPF) as described herein such as UPF 840 and 1040. The XR video application 1145 transmits an I-frame as a plurality of PDUs, the PDUs grouped to form a PDU set. The XR video application 1145 also transmits a P-frame as a plurality of PDUs, those PDUs also grouped to form a PDU set. The XR application 1145 further transmits non-video frame information as a plurality of PDUs, the PDUs grouped to form a yet further PDU set. The non-video frame information may comprise audio OPUS codec and/or AR metadata non-marked with PDU set info, for example. The UPF 1140 is arranged to receive PDUs from the XR video application 1145 and to transmit PDUs to the RAN 1130 a QoS flow having PDSB/PSER requirements. The UPF 1140 includes PDU set information with PDUs from the XR video application 1145 that comprise video information. The UPF 1140 does not include PDU set information with PDUs from the XR video application 1145 that relate to non-video frame information. The RAN 1130 transmits PDUs to the UE 1135 via a Uu radio bearer.

The two scenarios described above with reference to FIGS. 10 and 11 indicate that on a DRB mapped to a QoS Flow enabled with the PDU set feature for an XR application, the RAN may receive packets mixed, i.e., some of which are marked with the PDU Set information and some of which are not marked with the PDU Set information. The packets (which are PDUs) not marked with PDU set information may be referred to as “legacy packets”. These legacy packets are nonetheless handled under the same QoS characteristics of the QoS Flow (i.e., PSDB, PSER, PER and respectively PDB at a minimum). As a result, the RAN complexity is increased as different handling and scheduling of radio resources is necessary for packets belonging on the same QoS Flow.

Furthermore, the 3GPP RAN has decided to eliminate such complexity in the 5GS at lower layers by taking out of scope of further normative specification the mapping M-1-M illustrated in FIG. 9d, whereby the packets of a QoS Flow are split over multiple DRBs.

The different treatment at the radio level of packets on the same QoS Flow is thus not currently possible. As such, the QoS policies and PDU Set marking features within 5GS need to further alleviate this while maintaining a lower complexity at the RAN level and attain a good complexity-performance trade-off at the system level.

There is presented herein a solution to these issues whereby policies are introduced for handling XR application traffic with PDU Set feature supported under the two scenarios described above.

There is described herein a uniform treatment of both marked PDU Set packets and non-marked PDU Set packets upon their mapping to a suitable QoS Flow established to support the PDU set QoS requirements requested by a 3^{rd} party application. The current agreement is that an existing QoS flow (with legacy QoS requirements, e.g. PDB) is enhanced to support the QoS requirements of a PDU-set (PDU set delay budget, PDU set error rate). If both packets marked with PDU-set information and unmarked packets are sent via such a QoS flow, then the complexity at the RAN increases as the RAN will need to accommodate scheduling resources for PDUs of a PDU-set according to the PDU set delay budget (PDSB) and scheduling resources for non-marked PDU-set packets based on the legacy PDB of the QoS flow, where the PDSB value is higher than the legacy PDB. The solution presented herein comprises enforcing a policy that a QoS Flow enabled with the PDU Set marking must have all the PDUs in the downlink direction marked with PDU Set information upon ingestion into the 5GS over the UPF via the N6 interface. This policy results in a QoS Flow enabled with the PDU Set marking will always contain only packets marked with the PDU Set information.

The enforced policy may be phrased as “The UPF shall include PDU set information within GTP-U header, for any packet in the downlink direction that is determined to be sent via QoS flow with PDU set information marking, based on SMF instructions.”

Some examples of the policy and its representation within the 5GS are presented herein. These are example instantiations of the policy and should not be seen by any means as restrictions of the policy core intention.

For example, the policy may comprise ensuring a QoS flow with PDU-set requirements only includes packets marked with PDU-set information. In such an arrangement, the UPF receives N4 rules from the SMF. The N4 rules include information to assist the UPF to identify how a packet received in the downlink direction needs to be routed over an established QoS flow and whether PDU-set information is needed to be added for any packet sent over a QoS flow that has specific PDU-set QoS requirements.

The SMF determines N4 rules based on a PCC rule provided by the PCF. The PCF determines PCC rules based on the PDU-set QoS requirements of an application user plane session to a UE via the 3GPP network (AF session) provided by an Application Function.

The AF session PDU-set QoS requirements include PDU set delay budget, PDU set error rate and PDU set integrated handling indicator (PSIHI) which are described in clause 5.7.7 of 3GPP TS 23.501 (v18.1.0—April 2023) titled “System architecture for the 5G System (5GS)”. In addition, the AF provides the Protocol Description which indicates protocol (e.g. RTP/SRTP) and payload type (e.g. H.264) used by the service data flow that needs to support specific PDUs-set QoS requirements over the 3GPP network.

When the UPF receives packets in the downlink direction (over N6 reference point), the UPF checks if the packet matches any of the N4 rules provided by the PCF/SMF of the UE.

Should the UPF determine that for a received packet in the downlink direction PDU-set inspection needs to be performed (based on the N4 rule) the PSA UPF can identify the PDU Set information using the Protocol Description and the received RTP/SRTP headers or using implementation specific means. The UPF then determines and adds all or some combination of the following information when the packet is sent to the NG-RAN within GTP-U header:
PDU Set Sequence Number.
Indication of End PDU of the PDU Set.
PDU Sequence Number within a PDU Set.
PDU Set Size in bytes.
PDU Set Importance, which identifies the relative importance of a PDU Set compared to other PDU Sets within a QoS Flow.

If the packet received in the downlink direction matches the protocol description in the N4 rule then there are two additional options that need to be considered:
Option 1: The received packet may not have any additional RTP header extension which include PDU-set information (e.g. PDU-set size). In that scenario the UPF determines PDU-set information based on its implementation.
Option 2: Some of the received packets include RTP header extension with additional information containing PDU-set information provided by the application server. In this scenario, the UPF must include the information contained within RTP header extension to corresponding information within the PDU-set information within GTP-U header. Here, it is proposed that if the received packet does not have any PDU-set information within RTP header extensions the UPF to include for each packet (PDU), PDU-set information within GTP-U header when the packet is sent to the NG-RAN.

If the packet received in the downlink direction does not match the protocol description in the N4 rule, but the N4 rule includes an indication to perform PDU-set inspection, then for each received packet that does not match the protocol description, instead of the UPF to send the packet/PDU unmarked over the QoS flow with PDU-set QoS requirements, the UPF includes default PDU-set information within the GTP-U header when the packet is sent to the NG-RAN. In this situation the PDU-set size would correspond to the size of the received packet.

Accordingly, there is provided a User Plane Function (UPF), comprising a processor and a memory coupled with the processor, the memory containing instructions which when executed by the processor cause the UPF to: receive a Protocol Data Unit (PDU) in a downlink direction the received PDU subject to PDU-set processing according to configuration information received from a Session Management Function (SMF) wherein the configuration information comprises a protocol description; and determine whether: the received PDU does not match all components of the configuration information received from the SMF; or the received PDU does match the protocol description of the configuration information but that the received PDU is not part of a PDU-set. The UPF is further caused to create a header for the received PDU, the header including PDU-set information if either: the received PDU does not match all components of the configuration information received from the SMF; or the received PDU does match the protocol description of the configuration information but that the received PDU is not part of a PDU-set. The processor is further caused to route the received PDU and the header to a radio access network.

The received PDU may be a PDU belonging to a PDU-set. The method may be suitable for routing a packet over a QoS flow in accordance with PDU-set requirements. The PDU-set requirements may be defined by the PDU-set control information. The radio access network may comprise an NG-RAN. The radio access network may comprise a 5GS.

The method and apparatus described herein tends to result in improved marking of PDUs in the downlink direction. To ensure proper operation of the radio access network, a QoS Flow enabled with PDU Set marking should have all the PDUs in the downlink direction marked with PDU Set information upon ingestion into the radio access network.

The protocol description may indicate PDU-set processing. The received PDU may further comprise at least one protocol extension header. The protocol extension header may contain PDU-set information.

The PDU and header are routed towards a radio access network together. The radio access network may comprise an NG-RAN. The received PDU may be sent towards the NG-RAN via GTP-U protocol. The header may be a GTP-U header. The received PDU may be sent towards the NG-RAN and the PDU-set information may be included within a GTP-U header of the GTP-U protocol PDU-set information.

The processor may be further arranged to cause the UPF to: determine whether the received PDU includes a protocol extension header; determine whether the protocol extension header includes PDU set information; and if the received PDU includes a protocol extension header and if the protocol extension header does not include PDU set information, then the processor is further arranged to include PDU-set information in the header.

The processor may be further arranged to cause the UPF to determine whether the received PDU includes a protocol extension header; and, if the received PDU does not include a protocol extension header, then the processor is further arranged to cause the UPF to determine if the PDU is part of a PDU-set based on implementation.

If the PDU is not part of a PDU-set, then the processor may be further arranged to cause the UPF to create a header for the received PDU. The configuration information may be received from the SMF in an N4 rule. The received PDU may be received in a downlink direction over N6. The header may comprise PDU-set information that includes PDU-set size. The protocol description may include protocol and payload type of the information contained within the received PDU.

The processor may be further arranged to cause the UPF to: determine whether the received PDU does not include PDU-set information; and create the header to include the PDU-set information if the received PDU does not include PDU-set information.

The protocol description may be provided to the PDU by an application function. The protocol description may indicate a protocol and payload type. The protocol may comprise RTP or SRTP, for example. The payload type may comprise H.264, for example. The protocol and payload type may be used by a service data flow. The service data flow may support specific PDU-set QoS requirements over the 3GPP network.

The PDU-set information included in the header may comprise at least one of: a PDU Set Sequence Number; an indication of an End PDU of the PDU Set; a PDU Sequence Number within a PDU Set; a PDU Set Size in bytes; a PDU Set Importance. The PDU set importance may identify the relative importance of a PDU Set compared to other PDU Sets within a QoS Flow.

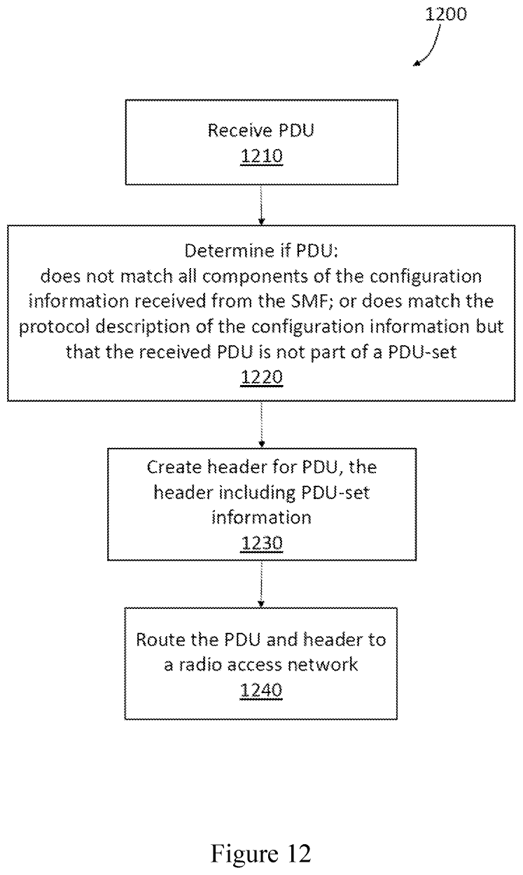

FIG. 12 illustrates a method 1200 performed by a User Plane Function (UPF), the method 1200 comprising: receiving 1210 a Protocol Data Unit (PDU) in a downlink direction the received PDU subject to PDU-set processing according to configuration information received from a Session Management Function (SMF) wherein the configuration information comprises a protocol description; and determining 1220 whether: the received PDU does not match all components of the configuration information received from the SMF; or the received PDU does match the protocol description of the configuration information but that the received PDU is not part of a PDU-set. The method 1200 further comprises creating 1230 a header for the received PDU, the header including PDU-set information if either: the received PDU does not match all components of the configuration information received from the SMF; or the received PDU does match the protocol description of the configuration information but that the received PDU is not part of a PDU-set. The method 1200 further still comprises routing 1240 the received PDU and the header to a radio access network.

In certain embodiments, the method 1200 may be performed by a processor executing program code, for example, a microcontroller, a microprocessor, a CPU, a GPU, an auxiliary processing unit, a FPGA, or the like.

The received PDU may be a PDU belonging to a PDU-set. The method may be suitable for routing a packet over a QoS flow in accordance with PDU-set requirements. The PDU-set requirements may be defined by the PDU-set control information. The radio access network may comprise an NG-RAN. The radio access network may comprise a 5GS.

The method tends to result in improved marking of PDUs in the downlink direction. To ensure proper operation of the radio access network, a QoS Flow enabled with PDU Set marking should have all the PDUs in the downlink direction marked with PDU Set information upon ingestion into the radio access network.

The protocol description may indicate PDU-set processing. The received PDU may further comprise at least one protocol extension header. The protocol extension header may contain PDU-set information.

The PDU and header are routed towards a radio access network together. The radio access network may comprise an NG-RAN. The received PDU may be sent towards the NG-RAN via GTP-U protocol. The header many be a GTP-U header. The received PDU may be sent towards the NG-RAN and the PDU-set information may be included within a GTP-U header of the GTP-U protocol PDU-set information.

The method may further comprise: determining whether the received PDU includes a protocol extension header; determining whether the protocol extension header includes PDU set information; and if the received PDU includes a protocol extension header and if the protocol extension header does not include PDU set information, then including PDU-set information in the header.

The method may further comprise determining whether the received PDU includes a protocol extension header; and, if the received PDU does not include a protocol extension header, determining if the PDU is part of a PDU-set based on implementation.

If the PDU is not part of a PDU-set, then the method may further comprise creating a header for the received PDU.

The configuration information may be received from the SMF in an N4 rule. The received PDU may be received in a downlink direction over N6. The header may comprise PDU-set information that includes PDU-set size. The protocol description may include protocol and payload type of the information contained within the received PDU.

The method may further comprise: determining whether the received PDU does not include PDU-set information; and creating the header to include the PDU-set information if the received PDU does not include PDU-set information.

The protocol description may be provided to the PDU by an application function. The protocol description may indicate a protocol and payload type. The protocol may comprise RTP or SRTP, for example. The payload type may comprise H.264, for example. The protocol and payload type may be used by a service data flow. The service data flow may support specific PDU-set QoS requirements over the 3GPP network.

The PDU-set information included in the header may comprise at least one of: a PDU Set Sequence Number; an indication of an End PDU of the PDU Set; a PDU Sequence Number within a PDU Set; a PDU Set Size in bytes; a PDU Set Importance. The PDU set importance may identify the relative importance of a PDU Set compared to other PDU Sets within a QoS Flow.

Accordingly, there is presented herein a method of PDU-set inspection handling by a UPF in case a received packet in the downlink does not match the protocol description in the N4 rule. There is further presented herein a method of PDU-set inspection handling by a UPF in case a received packet in the downlink direction matches the protocol description in the N4 rule but some of the packets received do not containing PDU-set information within RTP header extensions.

An existing QoS flow (with legacy QoS requirements, e.g. PDB) is enhanced to support the QoS requirements of a PDU-set (PDU set delay budget, PDU set error rate). A problem with such an arrangement is that if both packets marked with PDU-set information and unmarked packets are sent via such QoS flow the complexity at the RAN increases as the RAN will need to accommodate scheduling resources for PDUs of a PDU-set according to the PDU set delay budget (PDSB) and scheduling resources for non-marked PDU-set packets based on the legacy PDB of the QoS flow, where the PDSB value is higher than the legacy PDB.

There is presented herein a solution comprising enforcing a policy that a QoS Flow enabled with the PDU Set marking must have all the PDUs in the downlink direction marked with PDU Set information upon ingestion into the 5GS over the UPF via the N6 interface.

This policy requires that a QoS Flow enabled with PDU Set marking will always contain only packets marked with the PDU Set information.

This solution tends to improve upon existing arrangements whereby a UPF may use proprietary implementation means to determine PDU-set information for any received packet that matches a protocol description. Any packet that does not match the protocol description will need to be sent by the UPF over the QoS flow unmarked which increases the complexity at the RAN.

There is provided herein PDU-set inspection handling by the UPF in case a received packet in the downlink do not match the protocol description in the N4 rule. There is also provided herein PDU-set inspection handling by the UPF in case a received packet in the downlink direction matches the protocol description in the N4 rule but some of the packets received do not contain PDU-set information within RTP header extensions.

A received packet may not match a protocol description. There is provided herein a method wherein a UPF determines to route a packet over a QoS flow with PDU-set requirements and apply PDU-set inspection for a PDU received in the downlink direction (over N6) according to configuration information received from the SMF, wherein configuration information includes a protocol description; determines to include PDU-set information for any received PDU that do not match all components of the configuration information received from the SMF; and routes the received PDU to the NG-RAN and include within GTP-U header PDU-set information that includes PDU-set size.

The configuration information received from the SMF may be included in an N4 rule. The protocol description may include protocol and payload type of the information contained within the received PDU. The UPF may determine to include PDU-set information if the received PDU does not contain protocol and payload type information according to the protocol description received in the configuration information from the SMF.

There is further provided a method wherein a UPF determines to route a packet over a QOS flow with PDU-set requirements and apply PDU-set inspection for a PDU received in the downlink direction (over N6) according to configuration information received from the SMF, wherein configuration information includes a protocol description; determines to include PDU-set information for any received PDU that match the protocol description of the configuration rule but the received PDU do not include PDU-set information within the protocol extension headers; and routes the received PDU to the NG-RAN and include within GTP-U header information PDU-set information that includes PDU-set size. The configuration information received from the SMF may be included in an N4 rule.

It should be noted that the above-mentioned methods and apparatus illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communication standards, these examples are not intended to be the limit of the communication standards to which the disclosed method and apparatus may be applied. For example, while specific examples have been given in the context of 3GPP, the principles disclosed herein can also be applied to another wireless communication system, and indeed any communication system which uses routing rules.

The method may also be embodied in a set of instructions, stored on a computer readable medium, which when loaded into a computer processor, Digital Signal Processor (DSP) or similar, causes the processor to carry out the hereinbefore described methods.

The described methods and apparatus may be practiced in other specific forms. The described methods and apparatus are to be considered in all respects only as illustrative and not restrictive. The scope of the invention is, therefore, indicated by the appended claims rather than by the foregoing description. All changes which come within the meaning and range of equivalency of the claims are to be embraced within their scope.

The following abbreviations are relevant in the field addressed by this document: 3GPP, 3rd generation partnership project; 5G, fifth generation; 5GS, 5G System; 5QI, 5G QoS Identifier; AF, application function; AMF, access and mobility function; AR, augmented reality; AS, application server; DL, downlink; NAL, network abstraction layer; PCF, policy control function; PDU, packet data unit; PPS, picture parameter set; QoE, quality of experience; QoS, quality of service; RAN, radio access network; RTCP, real-time control protocol; RTP, real-time protocol; SDAP, service data adaptation protocol; SMF, session management function; SRTCP, secure real-time control protocol; SRTP, secure real-time protocol; UE, user equipment; UL, uplink; UPF, user plane function; VCL, video coding layer; VMAF, video multi-method assessment function; VPS, video parameter set; VR, virtual reality; XR, extended reality; XR AS, XR application server; and XRM, XR media.

1. A user plane function (UPF) for wireless communication, comprising:
at least one memory; and
at least one processor coupled with the at least one memory and configured to cause the UPF to:
receive a protocol data unit (PDU) in a downlink direction, the received PDU subject to PDU-set processing according to configuration information received from a session management function (SMF), the configuration information comprises a protocol description;
determine whether the received PDU does not match all components of the configuration information received from the SMF, or the received PDU does match the protocol description of the configuration information and the received PDU is not part of a PDU-set;
create a header for the received PDU, the header including PDU set information if either the received PDU does not match all of the components of the configuration information received from the SMF, or the received PDU does match the protocol description of the configuration information and the received PDU is not part of the PDU-set; and
route the received PDU and the header to a radio access network.

2. The UPF of claim 1, wherein the at least one processor is configured to cause the UPF to:
determine whether the received PDU includes a protocol extension header;
determine whether the protocol extension header includes the PDU-set information; and
if the received PDU includes the protocol extension header and if the protocol extension header does not include the PDU-set information, then include the PDU-set information in the header.

3. The UPF of claim 1, wherein the at least one processor is configured to cause the UPF to:
determine whether the received PDU includes a protocol extension header; and
if the received PDU does not include the protocol extension header, then determine if the PDU is part of the PDU-set based at least in part on implementation.

4. The UPF of claim 3, wherein if the received PDU is not part of the PDU set, then the at least one processor is configured to cause the UPF to create the header for the received PDU.

5. The UPF of claim 1, wherein the header comprises the PDU-set information that includes a PDU-set size.

6. The UPF of claim 1, wherein the protocol description includes a protocol and payload type of the information contained within the received PDU.

7. The UPF of claim 1, wherein the at least one processor is configured to cause the UPF to:
determine whether the received PDU does not include the PDU-set information; and
create the header to include the PDU-set information if the received PDU does not include the PDU-set information.

8. The UPF of claim 1, wherein the protocol description is provided to the PDU by an application function.

9. The UPF of claim 1, wherein the protocol description indicates a protocol and payload type.

10. The UPF of claim 1, wherein the PDU-set information included in the header comprises at least one of:
a PDU-set sequence number;
an indication of an end PDU of the PDU-set;
a PDU sequence number within the PDU-set;
a PDU-set size in bytes; or
a PDU-set importance.

11. A method performed by a user plane function (UPF), the method comprising:
receiving a protocol data unit (PDU) in a downlink direction, the received PDU subject to PDU-set processing according to configuration information received from a session management function (SMF) wherein the configuration information comprises a protocol description;
determining whether the received PDU does not match all components of the configuration information received from the SMF, or the received PDU does match the protocol description of the configuration information and the received PDU is not part of a PDU-set;
creating a header for the received PDU, the header including PDU-set information if either the received PDU does not match all of the components of the configuration information received from the SMF, or the received PDU does match the protocol description of the configuration information and the received PDU is not part of the PDU-set; and
routing the received PDU and the header to a radio access network.

12. The method of claim 11, further comprising:
determining whether the received PDU includes a protocol extension header;
determining whether the protocol extension header includes the PDU-set information; and
if the received PDU includes the protocol extension header and if the protocol extension header does not include the PDU-set information, then including the PDU-set information in the header.

13. The method of claim 11, further comprising:
determining whether the received PDU includes a protocol extension header; and
if the received PDU does not include the protocol extension header, determining if the PDU is part of the PDU-set based at least in part on implementation.

14. The method of claim 13, wherein if the received PDU is not part of the PDU-set, then the method further comprising creating the header for the received PDU.

15. The method of claim 11, wherein the header comprises the PDU-set information that includes a PDU-set size.

16. The method of claim 11, wherein the protocol description includes a protocol and payload type of the information contained within the received PDU.

17. The method of claim 11, further comprising:
determining whether the received PDU does not include the PDU-set information; and
creating the header to include the PDU-set information if the received PDU does not include the PDU-set information.

18. The method of claim 11, wherein the protocol description is provided to the PDU by an application function.

19. The method of claim 11, wherein the PDU-set information included in the header comprises at least one of:
a PDU set sequence number;
an indication of an end PDU of the PDU-set;
a PDU sequence number within the PDU-set;
a PDU-set size in bytes; or
a PDU-set importance.

20. A processor for wireless communication, comprising:
at least one controller coupled with at least one memory and configured to cause the processor to:
receive a protocol data unit (PDU) in a downlink direction, the received PDU subject to PDU-set processing according to configuration information received from a session management function (SMF), the configuration information comprises a protocol description;
determine whether the received PDU does not match all components of the configuration information received from the SMF, or the received PDU does match the protocol description of the configuration information and the received PDU is not part of a PDU-set;
create a header for the received PDU, the header including PDU set information if either the received PDU does not match all of the components of the configuration information received from the SMF, or the received PDU does match the protocol description of the configuration information and the received PDU is not part of the PDU-set; and
route the received PDU and the header to a radio access network.
